(19) United States
(12) Patent Application Publication
(10) Pub. No.: US 2006/0177536 A1
(43) Pub. Date: Aug. 10, 2006

(54) Apparatus for blow molding

(76) Inventors: Christian S. Boden, LaSalle, MI (US); A. Dale Maddox, Tecumseh, MI (US); Robert L. Padley JR., Brooklyn, MI (US)

Correspondence Address: MILACRON INC., 2090 FLORENCE AVE., CINCINNATI, OH, 45206, US

(21) Appl. No.: 11/053,297

(22) Filed: Feb. 8, 2005

(51) Int. Cl. B29C 49/70

(52) U.S. Cl. 425/525; 425/526; 425/537

(57) ABSTRACT

A mold assembly for blow molding comprises mating mold components having opposed mating surfaces and each comprising an insert defining the exterior of a neck portion of the article to be molded and at least one heat pipe located with one end thereof proximate a molding surface and the other end thereof in the interior of a heat transfer fluid conducting passage within the mold component. Advantageously, each mold component includes sealing means effective to prevent passage of fluid from the mold component around heat pipes passing through walls thereof. Advantageously, each insert includes at least one knife insert for forming a parting groove for separating waste of the article as molded from the neck portion comprising a finished article. A blow molding machine comprises a mold assembly in accordance with the invention. Advantageously the molding machine comprises trimming means for parting the molded article at the parting grooves.

### I. BACKGROUND OF THE INVENTION

1. Field of the Invention

This invention relates generally to blow molding. In particular, this invention relates to mold assemblies for blow molding.

2. Description of Related Art

Blow molding is a cyclic process wherein a parison in a moldable condition is centered on the parting plane of a mold assembly, the mold assembly is closed around the parison, the parison is expanded so the exterior of the parison abuts molding surfaces defined by the closed mold assembly, the blow molded article is conditioned to be sufficiently rigid to retain its size and shape while unsupported without unacceptable deformation, the mold assembly is opened and the blow molded article is removed. In general, the moldable condition of the parison is achieved when the material of the parison is at an elevated temperature, and the rigid condition of the blow molded article is achieved when the temperature of the material has been reduced. A blow molding machine comprises a press for opening and closing the mold assembly, blowing means for introducing a pressurized fluid (typically air) to expand the parison in the mold assembly, and manipulating means for removing the blow molded article from the mold assembly and trimming means for removing waste from the molded articles. Additionally, a blow molding machine may comprise heat transfer devices to elevate the temperature of the parison to achieve the moldable condition and to reduce the temperature of the blow molded article to achieve the rigid condition.

Blow molding is commonly used for production of containers comprising a body portion defining a closed end and a neck portion defining an open end of the container. Mold assemblies for blow molding containers comprise mating mold components wherein molding surfaces open to the mating faces of the mold components define the exterior of the container. Advantageously, the neck portion of the container comprises an exterior surface having a feature, such as a thread, called the “neck finish” for engaging a separable closure and the mating mold components comprise inserts for forming such features. In addition, the neck portion further comprises a dome element for handling the blow molded article, the dome element comprising a portion of the blow molded article which is eliminated from the finished container. Advantageously, the dome element comprises an external groove to be engaged by means of a blow molding machine for guiding the molded article after its removal from the mold assembly. As it is advantageous to apply various specifically defined neck portions to molded articles which are otherwise the same, mold components are supplied with replaceable inserts comprising molding surfaces defining the neck portion of the article to be molded.

It is conventional to provide mold components with internal passages for conducting heat transfer fluids. Effectiveness of heat transfer between molding surfaces and heat transfer fluid is directly affected by the number of heat transfer fluid passages and their proximity to the molding surfaces. Contours of molding surfaces characterized by reversals of slope over relatively short spans severely limit the practical ability to achieve close proximity of heat transfer fluid passages to molding surfaces. Further, the use of inserts comprising molding surfaces interposes boundaries between heat transfer fluid passages within the bodies of mold components and the mold surfaces of the inserts. Hence there is a need to provide improved heat transfer that overcomes the limitations of practical application of heat transfer fluid passages.

### II. SUMMARY OF THE INVENTION

It is an object of the present invention to provide a mold assembly for blow molding comprising two mating mold components having opposed mating faces and each having molding surfaces open to a mating face thereof and defining the exterior of a portion of an article to be molded and comprising an insert defining the exterior of a neck portion of the article to be molded, and at least one heat pipe located with one end thereof proximate a molding surface and the other end thereof in the interior of a passage within the mating mold component for conducting a heat transfer fluid.

It is a further object of the present invention to provide a blow molding machine comprising a mold assembly in accordance with the invention.

Further objects and advantages of the invention shall be made apparent from the accompanying drawings and the following description thereof.

In accordance with the aforesaid objects the present invention provides a mold assembly for blow molding comprising mating mold components, each mating mold component having a molding surface open to a mating face of the mold component and defining the exterior of a portion of an article to be molded, two of the mating mold components having opposed mating surfaces and each comprising an insert defining the exterior of a neck portion of the article to be molded, and at least one heat pipe located with one end thereof proximate a molding surface and the other end thereof in the interior of a passage within the mating mold component for conducting a heat transfer fluid. A blow molding machine comprises a press mechanism for operating a mold assembly and a mold assembly according to the invention mounted thereto.

### III. BRIEF DESCRIPTION OF THE DRAWINGS

FIG. 1 is a three dimensional view of components of a mold assembly according to the invention with a parison therebetween.

FIGS. 2a and 2b are three dimensional views of a mold component and insert therefore of FIG. 1.

FIG. 3 is a partial sectional view taken along line 3-3 of FIG. 1.

FIG. 4 is a partial sectional view taken along line 4-4 of FIG. 1.

### IV. DETAILED DESCRIPTION OF THE PREFERRED EMBODIMENT

The invention shall be illustrated with reference to a preferred embodiment which shall be described in detail. It is not the intention of applicant that the invention be limited to the preferred embodiment, but rather that the invention shall be defined by the appended claims and all equivalents thereof.

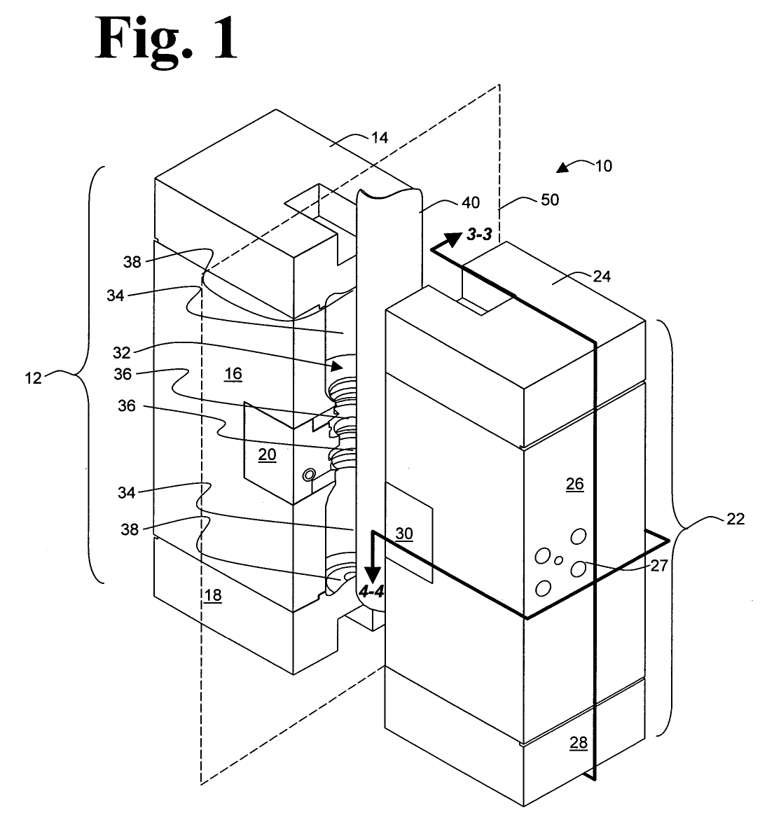

Referring to FIG. 1, mold assembly 10 comprises mating mold components 12 and 22 each referred to herein as a “mold half”. Each of mold components 12 and 22 is carried by a member of a molding machine press (not shown) for translating the mold components between open and closed positions relative to each other (the open position depicted in FIG. 1). In the open position, mold components 12 and 22 are separated permitting admission of a parison such as parison 40 therebetween and removal of a molded article upon completion of a molding operation. In the closed position, mold components 12 and 22 abut at parting plane 50, the abutting faces of mold components 12 and 22 having molding surfaces thereon defining a cavity. The cavity shown in FIG. 1 is a double cavity, i.e., a cavity for simultaneously blow molding two containers as a unitary, closed hollow article, the neck portions of each container being joined. Molding surfaces of mold components 12 and 22 define the containers in opposed relationship with an extension joining the domes of the neck portions thereof. Hence, the containers lie on the same longitudinal centerline and the cavity is symmetrical about an imaginary plane transverse to the mold halves at the horizontal centerline of the cavity. Parison 50 is tubular, typically produced by extrusion of flowable material through a die (not shown) above mold assembly 10. Parison 40 is formed with a length extending below the lowest molding surface of the cavity. With the molds closed surrounding the parison, the parison is pinched closed at ends of the cavity and pressurized to expand the parison material to abut the molding surfaces of the cavity.

Continuing with reference to FIG. 1, the portion 32 of the cavity defined by mold component 12 comprises molding surfaces 34, 36 and 38. Molding surfaces 34 define the bodies of the containers; molding surfaces 36 define the neck portions of the containers and, molding surfaces 38 define the base portions of the containers. Mold component 12 comprises center section 16 comprising molding surfaces 34; end sections 14 and 18 comprising molding surfaces 38 and, insert 20 comprising molding surfaces 36. The corresponding sections of mold component 22 are center section 26, end sections 24 and 28 and insert 30. Each of sections 22-30 comprise molding surfaces substantially mirroring molding surfaces 34, 36 and 38, respectively. With mold components 12 and 22 in the closed position surrounding a parison, the parison is pressurized by admission of a pressurizing fluid through a needle entering the parison at one of inserts 20 and 30. Connections, such as connection 27 in center section 26, for supply of the pressurizing fluid are provided in the one of mold components 12 and 22 comprising the needle.

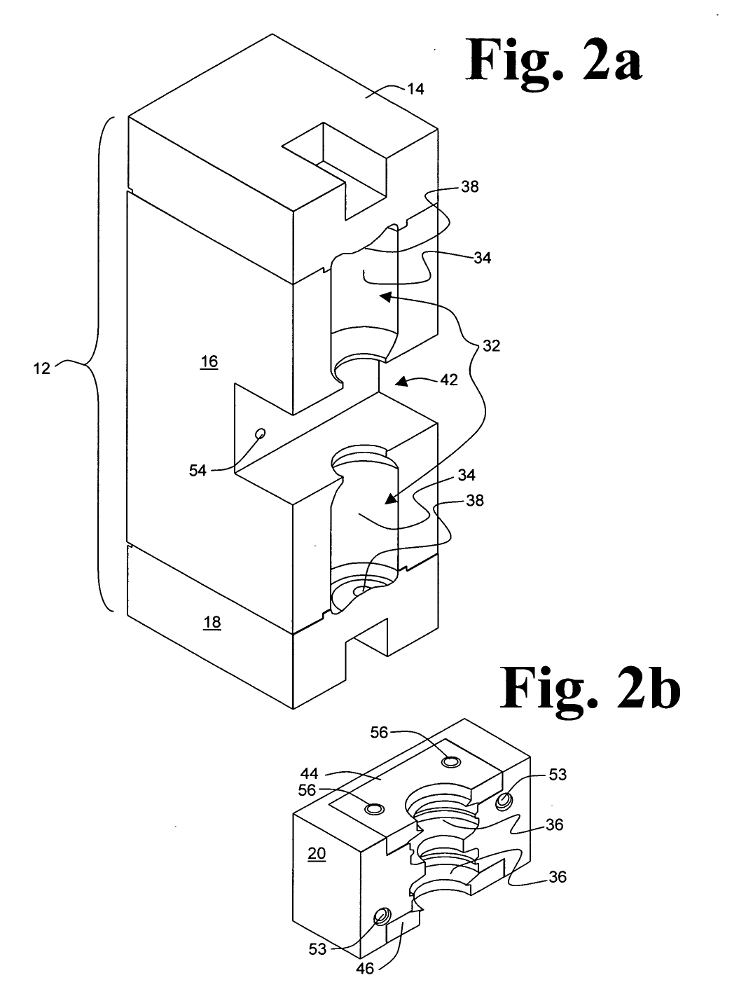

Referring to FIGS. 2a and 2b, mold component 12 is shown with insert 20 removed. Mold component 12 comprises recess 42 for receiving insert 20. Insert 20 is attached to mold component 12 by, for example, fasteners such as bolt 52 engaging threaded bore 54 in center section 16. Bolts 52 are accessible from the parting plane face of insert 20, facilitating replacement of insert 20 without removal of mold component 12 from the molding machine press. A corresponding recess is provided in mold component 22 for insert 30 which is similarly attached to mold component 22. In FIG. 2b, bore 53 for attaching bolt 52 is shown in the front face of insert 20. Referring to FIGS. 2a and 2b, inserts 20 and 30 comprise molding surfaces 36 defining the dome and neck finish of each of the two containers defined by the molding surfaces of mold components 12 and 22. A parting groove is formed in the periphery of the molded article between the neck finish and dome of each container by relatively sharp edged knife inserts 44 and 46. As molded, two containers are joined by an extension between the dome of each container, the extension comprising waste of the article as molded. Processing of the molded article after blow molding separates the two containers by parting the domes from the containers at the parting grooves created by the knife inserts 44 and 46. Advantageously, a blow molding machine comprises trimming means for parting the molded article at the parting grooves thereof. In addition to forming the parting grooves, each of knife inserts 44 and 46 comprise molding surfaces for the neck finish of a container. The form of the neck finish and the height thereof are determined by the molding surfaces in each knife insert and the location relative thereto of the parting groove forming edge. Variations of these features are adopted for particular closures that may be applied to the container. Hence, as is customary, knife inserts are provided to facilitate substitution of mold elements defining these features. The use of knife inserts increases the inefficiency of heat transfer from the neck portions of the molded article as the boundaries between knife inserts 44 and 46 and seating recesses therefore in insert 20 reduce heat transfer efficiency through the knife inserts to insert 20.

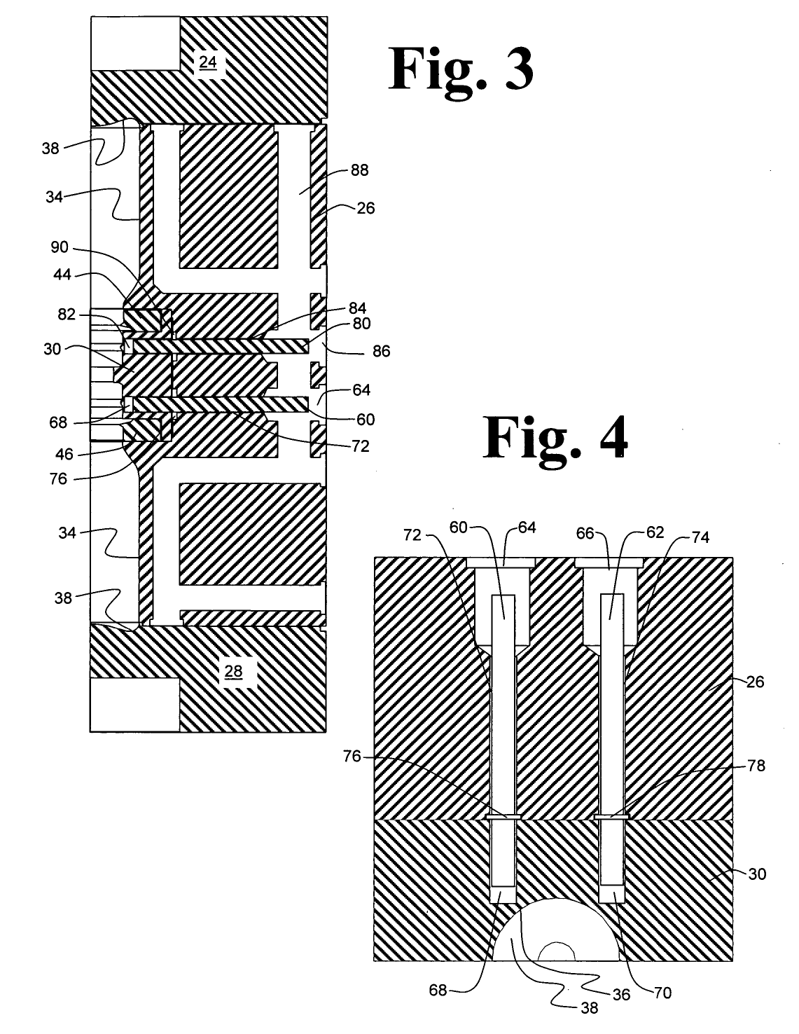

In accordance with the invention, heat pipes are provided within the mating mold components to improve overall efficiency of heat transfer from the molding surfaces. Each heat pipe comprises a sealed cylinder containing a wicking material and a working fluid. With opposite ends of the heat pipe proximate thermal masses at different temperatures, the working fluid is evaporated from heat transferred to the heat pipe at one end and the resulting vapor is condensed back to a fluid with transfer of heat from the heat pipe at the opposite end. The working fluid is transported through the wicking material to the end of the pipe where heat is being transferred to the heat pipe and the vapor is transported through the pipe to the end where heat is transferred from the heat pipe. Referring to FIGS. 3 and 4, partial cross sections of mold component 22 reveal locations of internal heat pipes for transfer of heat from insert 30 proximate the molding surface to a heat transfer fluid conducted through passages in center section 26. In each of FIGS. 3 and 4 two heat pipes are shown in correspondence with the arrangement of heat pipes and the partial cross sections depicted. The number and location of heat pipes is chosen with consideration given to the molding surfaces of the insert and the arrangement of heat transfer fluid conducting passages in center section 26. Heat pipes 60, 62 and 80 are received within bores 68, 70 and 82 respectively, of insert 30. The ends of heat pipes 60, 62 and 80 within insert 30 being proximate the portion of molding surface 36 comprising the groove of the dome portion of the neck. Heat pipes 60, 62 and 80 are supported in bores 72, 74 and 84, respectively, in center section 26 and each has an end therein projecting into a heat transfer fluid conducting passage within center section 26. As shown in FIGS. 3 and 4, bores 64, 66 and 86 comprise heat transfer fluid conducting passages within center section 26 and advantageously comprise fittings for connection of heat transfer fluid conduits to mold assembly 10. As seen in FIG. 3, heat transfer fluid conducting passage 88 is comprised of interconnected segments, including segments terminating at the boundaries of center section 26 to which end sections 24 and 28 are attached, and segments interconnecting bores 64, 66 and 86. In use, heat is transferred from insert 30 to heat pipes 60, 62 and 80 and from heat pipes to heat transfer fluid being conducted through passages within center section 26. A seal, such as an “O” ring seal, is fitted at the intersection of each of bores 72, 74 and 84 with the wall of insert receiving recess 42 of center section 26. Each of seals 76, 78 and 90 surround the heat pipe passing through the recess wall and is effective to prevent heat transfer fluid from passing out of center section 26 around the heat pipe. As shown in FIGS. 3 and 4, heat pipes 60, 63 and 80 are located so that the ends thereof within insert 30 are proximate knife inserts 44 and 46. This arrangement is consistent with the increased ineffectiveness of heat transfer from the molding surfaces comprising knife inserts 44 and 46 attributable to the boundaries interposed between those molding surfaces and the body of insert 30.

An advantage of use of heat pipes for heat transfer from insert 30 is the elimination of connections for conduction of heat transfer fluid to the interior of insert 30. An arrangement of heat pipes shown and described with reference to FIGS. 3 and 4 is advantageously included in center section 16 and insert 20. Although illustrated as applied to a mold assembly comprising a double cavity, the use of heat pipes is advantageously applied to mold assemblies having single cavities. Further, although shown and described with reference to the application of heat pipes for transfer of heat from molding surfaces of inserts 20 and 30, heat pipes are advantageously applied elsewhere in mold components of mold assemblies for blow molding. The locations of heat pipes are chosen in accordance with overall design of the mold component to provide improved heat transfer effectiveness from molding surfaces.

What is claimed is:

1. A mold assembly for blow molding comprising mating mold components, each mating mold component having a molding surface open to a mating face of the mold component and defining the exterior of a portion of an article to be molded, two of the mating mold components having opposed mating surfaces and each comprising an insert defining the exterior of a neck portion of the article to be molded, and at least one heat pipe located with one end thereof proximate a molding surface and the other end thereof in the interior of a passage within the mating mold component for conducting a heat transfer fluid.

2. The mold assembly according to claim 1 wherein the end of at least one heat pipe proximate a molding surface is proximate a molding surface of the insert.

3. The mold assembly according to claim 2 wherein each insert is received in a recess of the mold component it comprises, and the mold assembly further comprises a seal surrounding each heat pipe passing through a wall of the recess, the seal effective to prevent heat transfer fluid from passing out of the mold component around the heat pipe.

4. The mold assembly according to claim 2 wherein each insert further comprises at least one knife insert for forming a parting groove for separating waste of the article as molded from the neck portion comprising a finished article, the knife inserts being received in recesses therefore in the insert and the end of at least one heat pipe located within an insert is located within the insert to improve heat transfer effectiveness from the molding surfaces of the insert and a knife insert thereof.

5. The mold assembly according to claim 4 wherein the molded article comprises a container and the molding surfaces of the insert and knife inserts define a dome and neck finish comprising an exterior feature of the neck portion for engaging a closure for closing the container.

6. The mold assembly according to claim 5 wherein the dome component comprises a groove for engagement with means for guiding the molded article after its removal from the mold assembly.

7. The mold assembly according to claim 1 wherein the molding surfaces of the mold components comprise at least one cavity defining two containers arranged with the neck portions thereof joined so as to form a unitary, closed hollow article.

8. The mold assembly according to claim 7 wherein each insert further comprises two knife inserts, each knife insert forming a parting groove for separating waste of the article as molded from the neck portion comprising a container, the knife inserts being received in recesses therefore in the insert and the ends of at least two heat pipes are located within the insert proximate the knife inserts to improve heat transfer effectiveness from the molding surfaces of the insert and the knife inserts thereof.

9. The mold assembly according to claim 8 wherein the neck portion of each container comprises a dome and neck finish comprising an exterior feature of the neck portion for engaging a closure for closing the container and the neck portions are joined by an extension joining the domes, the extension comprising waste of the article as molded.

10. A blow molding machine comprising a press mechanism for operating a mold assembly, the mold assembly comprising mating mold components, each mating mold component having a molding surface open to a mating face of the mold component and defining the exterior of a portion of an article to be molded, two of the mating mold components having opposed mating surfaces and each comprising an insert defining the exterior of a neck portion of the article to be molded, and at least one heat pipe located with one end thereof proximate a molding surface and the other end thereof in the interior of a passage within the mating mold component for conducting a heat transfer fluid.

11. The blow molding machine according to claim 10 wherein the end of at least one heat pipe proximate a molding surface is proximate a molding surface of the insert.

12. The blow molding machine according to claim 11 wherein each insert is received in a recess of the mold component it comprises, and the mold assembly further comprises a seal surrounding each heat pipe passing through a wall of the recess, the seal effective to prevent heat transfer fluid from passing out of the mold component around the heat pipe.

13. The blow molding machine according to claim 10 wherein each insert further comprises at least one knife insert for forming a parting groove for separating waste of the article as molded from the neck portion comprising a finished article, the knife inserts being received in recesses therefore in the insert and the end of at least one heat pipe located within the insert is located to improve heat transfer effectiveness from the molding surfaces of the insert and a knife insert thereof and the blow molding machine further comprises trimming means for parting the molded article at the parting groove.

14. The blow molding machine according to claim 13 wherein the molded article comprises a container and the molding surfaces of the insert and knife inserts define a dome and neck finish comprising an exterior feature of the neck portion for engaging a closure for closing the container.

15. The blow molding machine according to claim 14 wherein the dome component comprises a groove for engagement with means for guiding the molded articles after removal from the mold assembly.

16. The blow molding machine according to claim 10 wherein the molding surfaces of the mold components comprise at least one cavity defining two containers arranged with the neck portions thereof joined so as to form a unitary, closed hollow article.

17. The blow molding machine according to claim 16 wherein each insert further comprises two knife inserts, each knife insert forming a parting groove for separating waste of the article as molded from the neck portion comprising a container, the knife inserts being received in recesses therefore in the insert and the ends of at least two heat pipes located within the insert are proximate the knife inserts to improve heat transfer effectiveness from the molding surfaces of the insert and the knife inserts thereof and the blow molding machine further comprises trimming means for parting the molded articles at the parting grooves thereof.

18. The mold assembly according to claim 17 wherein the neck portion of each container comprises a dome and neck finish comprising an exterior feature of the neck portion for engaging a closure for closing the container and the neck portions are joined by an extension joining the domes, the extension comprising waste of the article as molded.
